(19) United States
(12) Patent Application Publication
(10) Pub. No.: US 2013/0227709 A1
(43) Pub. Date: Aug. 29, 2013

(54) Content Control System

(71) Applicant: William Geoffrey Herbert, Santa Monica, CA (US)

(72) Inventor: William Geoffrey Herbert, Santa Monica, CA (US)

(21) Appl. No.: 13/706,266

(22) Filed: Dec. 5, 2012

Related U.S. Application Data
(60) Provisional application No. 61/602,788, filed on Feb. 24, 2012.

(51) Int. Cl. G06F 21/60

(52) U.S. Cl. CPC G06F 21/60
USPC 726/28

(57) ABSTRACT

The present invention relates to a content control system. The system allows a user to navigate the internet using a desktop computer and selectively access content at various websites. For example, if a user were to visit a news website, some of the online content may be locked. However, using the present invention, a user can selectively access the locked content by scanning a barcode associated with the locked content. In this example, the content on the news website may have a barcode (or QR code) next to it on a user's computer screen (e.g., desktop computer). The user can scan the barcode on the computer screen using a mobile device (e.g., mobile phone). By scanning the barcode, an app on the user's mobile device sends a signal that instructs the desired website to unlock the content, which allows the user to view the unlocked content on their desktop computer.

### CROSS-REFERENCE TO RELATED APPLICATIONS

This is a non-provisional application of U.S. Provisional Application No. 61/602,788, filed on Feb. 24, 2012, and entitled, “Content Control System.”

### BACKGROUND OF THE INVENTION

(1) Field of Invention

The present invention relates to a content control system and, more particularly, to a system that uses scannable codes to control access to online content.

(2) Description of Related Art

Although online content is often provided free of charge, content providers are always attempting to monetize access to the content. For example, some websites require that users create accounts to access and unlock the online content. While operable for monetizing the content, such system often drive users away as they may be reluctant to go through the process of creating multiple online accounts.

An attempt to create one payment system has been implemented through Paypal. Through Paypal, users are able to pay a variety of vendors using one payment account (i.e., their Paypal account). Thus, through Paypal or other online payment systems (such as Google Checkout), users are able to effectively manage content access with a single payment account. However, using such online payment methods still requires the user to manually log into their Paypal account to authorize each transaction. Further, if it is an online content provider, the content provider typically requires yet another account. For example, to access articles or other content on the Wall Street Journal website (WSJ.com), a user would need to create subscription account AND could optionally pay with a payment account (e.g., Paypal). Thus, accessing the content at WSJ.com could require a user to create and/or manage two separate accounts during each purchase attempt. Multiple accounts and logins are not desirable as they create confusion and require additional steps by the consumer or user.

Thus, a continuing need exists for a system that allows a user to easily access online content while providing a mechanism for content providers to monetize the content.

### SUMMARY OF INVENTION

The present invention relates to a system that uses scannable codes to control access to online content. The system includes one or more processors and a memory. The memory has instructions encoded thereon such that upon execution, the processor performs several operations as described below. F

For example, the system performs operations of transmitting a unique ID to a web browser with instructions that the unique ID be displayed as a scannable code on a webpage. Scan information is received regarding a scan of the scannable code on a user's mobile device. At least one action item is related to the unique ID is displayed to a user on the user's mobile device for user approval. Finally, the system receives user approval and facilitates the at least one action item, thereby allowing a user to scan a scannable code on the user's mobile device and, upon approval by the user, facilitate the at least one action item.

In another aspect, the unique ID is associated with locked content on the webpage such that the at least one action item includes a content description of locked content and a price for unlocking the locked content for access by the user on the user's mobile device, wherein through receiving user approval and facilitating the at least one action item, the content is unlocked.

Before transmitting the unique ID, the system performs operations of causing a webpage to be loaded having locked content on a user's computing device and transmitting a request to a merchant web server for the scannable code; sending metadata from the merchant web server to a content control center (CCC); associating the metadata with a unique alphanumeric value, the unique alphanumeric value being the unique ID; and transmitting the unique ID from the CCC to the merchant web server, such that the unique ID can thereafter be transmitted via the act of transmitting a unique ID to a web browser with instructions that the unique ID be rendered as a scannable code on a webpage.

In another aspect, the system performs operations of converting the scan of the scannable code into its corresponding constituent alphanumeric value; transmitting at least one of a user identification and the alphanumeric value to the CCC; retrieving, in the CCC, the metadata associated with the scannable code based on the alphanumeric value; and transmitting the content description and price for display on the user's mobile device, with the content description and price being displayed as the action item related to the unique ID for user approval.

In yet another aspect, receiving user approval and facilitating the at least one action item further comprises operations of transmitting user approval to the CCC; recording the user approval as a purchase transaction; transmitting a purchase confirmation from the CCC to the user's mobile device; sending authorization from the CCC to the merchant web server; polling the merchant web server for access authorization using the web browser on the user's computing device; and upon authorization, unlocking the locked content for access by the user on the user's computing device.

In another aspect, the metadata includes information selected from a group consisting of a description of the locked content, a price for unlocking the locked content, a merchant ID, a timestamp, and identifying information about the user's mobile device.

In receiving a scan of the scannable code on a user's mobile device, the scan can be an actual visual or optical scan of the scannable code or an intent action where the user's mobile device selects the barcode.

In another aspect, the unique ID represents an online donation such that the at least one action item is a description of the organization receiving the donation and an amount of the donation, wherein through receiving user approval and facilitating the at least one action item, a donation is provided to the organization receiving the donation. In this aspect, the system further performs operations of converting, on the user's mobile device, the scan of the scannable code into its corresponding constituent alphanumeric value; transmitting a user identification and the alphanumeric value to a content control center (CCC); retrieving, at the CCC, metadata associated with the scannable code based on the alphanumeric value; transmitting the description of the organization receiving the donation and an amount of the donation for display on the user's mobile device, with the organization receiving the donation and the amount of the donation being displayed as the action item related to the unique ID for user approval. Thus, receiving user approval and facilitating the at least one action item further comprises operations of transmitting user approval to the CCC; recording the user approval as a donation transaction; and transmitting a donation confirmation from the CCC to the user's mobile device.

Finally, the present invention also includes a computer program product and computer implemented method. The computer program product comprises computer-readable instructions stored on a non-transitory computer-readable medium that are executable by a computer for causing the computer to perform the operations described herein, while the method is directed to causing a computer to perform the listed operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a content control system of the present invention;

FIG. 2 is an illustration of a computer program product embodying one aspect of the present invention;

FIG. 3 is a flow chart illustrating the flow of information that provides for operation of the present invention; and

FIG. 4 is a flow chart illustrating the flow of information for an alternative aspect of the present invention.

### DETAILED DESCRIPTION

The present invention relates to a content control system and, more particularly, to a system that uses scannable codes to control access to online content. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a glossary of terms used in the description and claims is provided. Next, a description of various principal aspects of the present invention is provided. Subsequently, an introduction provides the reader with a general understanding of the present invention.

Finally, details of the present invention are provided to give an understanding of the specific aspects.

(1) Glossary

Before describing the specific details of the present invention, a glossary is provided in which various terms used herein and in the claims are defined. The glossary provided is intended to provide the reader with a general understanding of the intended meaning of the terms, but is not intended to convey the entire scope of each term. Rather, the glossary is intended to supplement the rest of the specification in more accurately explaining the terms used.

Content Control Center—The term “Content Control Center” or CCC as used with respect to this invention generally indicates a collection of software components that reside in memory, or in retrievable storage, and are executable by a processor to perform the operations described herein. For example, the CCC includes a user accessible API, a merchant accessible API, a private library, and any other software components that facilitate storage and the relevant operations.

Instructions—The term “instructions” as used with respect to this invention generally indicates a set of operations to be performed on a computer, and may represent pieces of a whole program or individual, separable, software modules. Non-limiting examples of “instructions” include computer program code (source or object code) and “hard-coded” electronics (i.e. computer operations coded into a computer chip). The “instructions” may be stored in the memory of a computer or on a non-transitory computer-readable medium such as a floppy disk, a CD-ROM, and a flash drive.

Intent Action—The term “intent action” as used with respect to this invention generally indicates a command to select or access an item as displayed on a screen. An intent action is applicable when a user is attempting to access material on the user's mobile device itself, as opposed to “scanning” a scannable code. In other words, it would be impossible for a user to use their mobile device to scan a scannable code as displayed on the mobile device itself. In this case, the mobile device would use an application to identify the scannable code and allow a user to identify their intent to scan that code by touching, selecting or otherwise indicating such an intent. The mobile device/application would then generate a virtual scan of the code as if it actually scanned the scannable code.

Private Library—The term “Private Library” as used with respect to this invention generally indicates the location of the databases, security, and business logic that is “private” because it is not accessible to the outside world. It is only accessible to the outside world through the Merchant API and User API. In short, the Private Library is another API that contains the stuff that is proprietary and needs to be kept secure.

(2) Principal Aspects

The present invention has three “principal” aspects. The first is a content control system. The content control system is typically in the form of a computer system operating software or in the form of a “hard-coded” instruction set. This system may be incorporated into a wide variety of devices that provide different functionalities. The second principal aspect is a method, typically in the form of software, operated using one or more data processors. The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

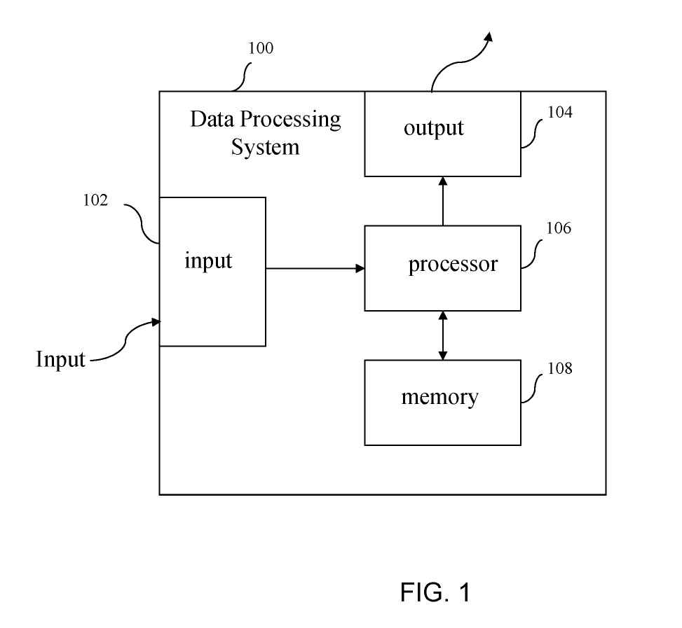

A block diagram depicting the components of a content control system of the present invention is provided in FIG. 1. The system 100 comprises an input 102 for receiving information from at least one user. Note that the input 102 may include multiple “ports.” Typically, input is received from at least one sensor, non-limiting examples of which include a CMOS sensor on a mobile phone, which can be used to scan a scannable bar code and provide data regarding the content to be accessed. Other inputs are provided by users as they create accounts, etc. An output 104 is connected with the processor for providing information regarding access to the content. Output may also be provided to other devices or other programs; e.g., to other software modules, for use therein. The input 102 and the output 104 are both coupled with a processor 106 (or processors), which may be a general-purpose computer processor or a specialized processor designed specifically for use with the present invention. The processor 106 is coupled with a memory 108 to permit storage of data and software that are to be manipulated by commands to the processor 106 that allow the processor 106 to perform the operations described herein.

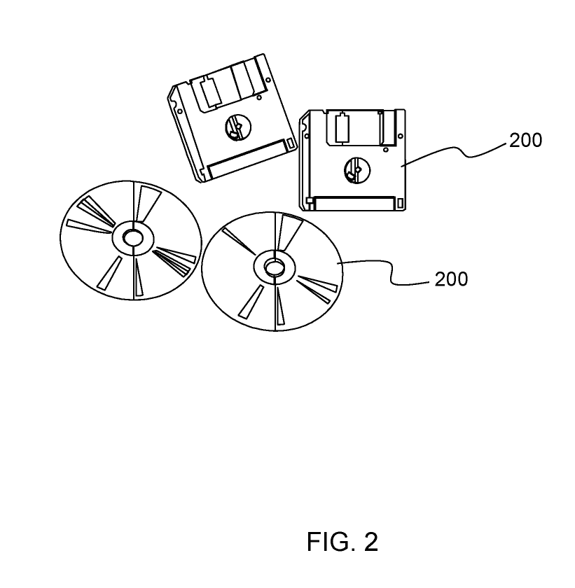

An illustrative diagram of a computer program product embodying the present invention is depicted in FIG. 2. The computer program product 200 is depicted as an optical disk such as a CD or DVD. However, as mentioned previously, the computer program product generally represents computer-readable instructions stored on any compatible non-transitory computer-readable medium. The instructions are executable by a computer having a processor, such that upon execution, the computer performs the operations described below. It should be noted that in operation, the present invention may require instructions to be stored on more than one device, such as an application as downloaded onto a user's mobile device and another internet accessible system having its own memory device (which can be embodied as the Content Control Center (CCC)).

(3) Introduction

The present invention relates to a content control system that uses scannable codes to control access to online content. As noted in the background section, existing online content control systems require a user to create an account and pay for access to the online content. The present invention approves upon the prior art by allowing a user to unlock content on their desktop computer using the scanner function of the user's smart phone.

The system allows a user to navigate the internet using a computing device (e.g., desktop computer) and selectively access locked content at various websites. It should be understood that although the system is described as navigating a desktop computer or computing device, both a tablet computer, and even the phone itself, could display the website that has the barcode. For example, if a user were to visit a news website, some of the online content (e.g., video, article, etc.) may be locked. However, using the present invention, a user can selectively access the locked content by scanning a barcode associated with the locked content. In this example, the content on the news website may have a barcode next to it on a user's computer screen (of their desktop computer). The user can scan the barcode on the computer screen using a mobile device (e.g., mobile phone, iPad, etc.). By scanning the barcode, an app on the user's mobile device sends a signal that ultimately instructs the desired website to unlock the content, which allows the user to view and/or access the unlocked content on their desktop computer.

It should be noted that the present invention may require an application that is downloaded onto a user's mobile phone, in conjunction with a server and other web enabled systems, as shown and described below. The specific details of the present invention are provided below.

(4) Details of the Invention

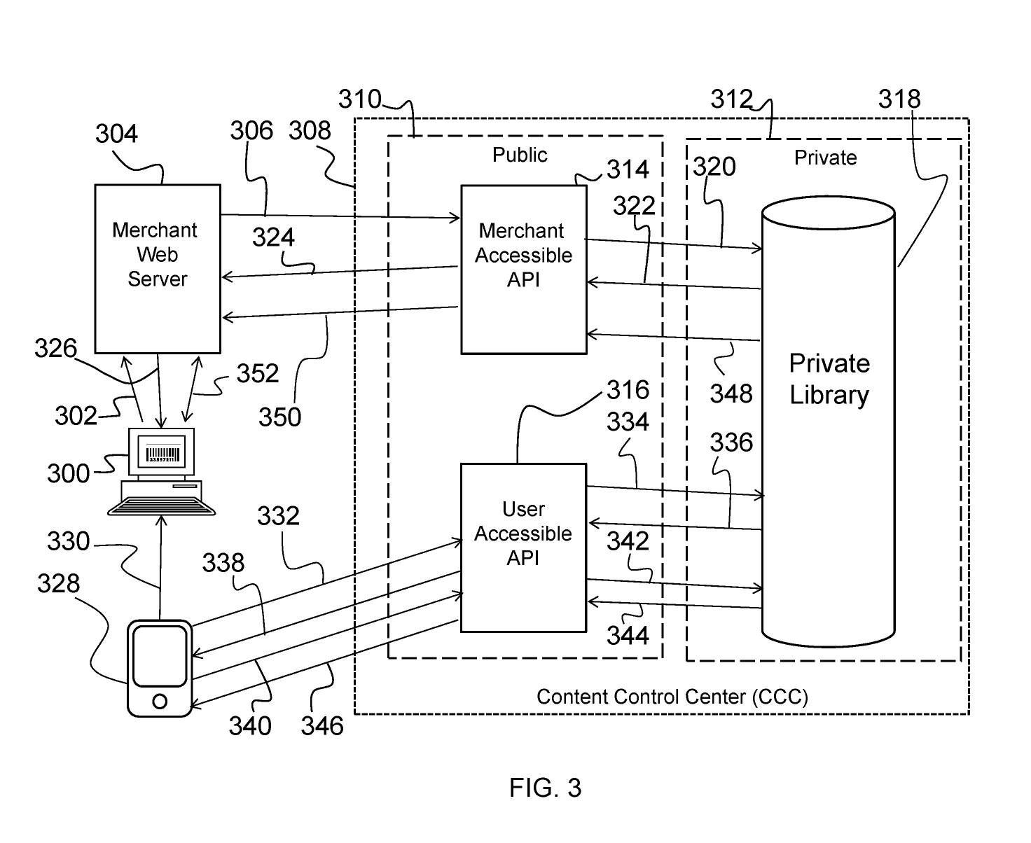

FIG. 3 is a flow chart illustrating the flow of information that provides for operation of the present invention. As noted above, the present invention is directed to a system that allows a user to access locked online content by a variety of merchants. In doing so, the user uses a computing device 300 to navigate the internet and access various web pages. With respect to the present invention, the user utilizes the computing device 300 to load a webpage having locked content. The webpage can be the webpage of a particular merchant or merchant content that is located on some other webpage. In loading the webpage (before, during, and/or after), the user's computing device transmits 302 a request to a merchant web server 304 for a scannable code (e.g., scannable barcode) which is displayed on the webpage of 300. Thereafter, the merchant web server 304 securely transmits 306 metadata to a content control center (CCC) 308.

The CCC 308 is any suitable system that can be used to manage the operations of the present invention and allows for the interface of software components to communicate with each other. In addition to having the memory and processor as required to operate the present invention (as depicted in FIG. 1), the CCC 308 includes a public side 310 and a private side 312. By public side 310, it is meant that both merchants and users are able to access the CCC 308 through flow communications, the internet, or other suitable techniques. By private side 312, it is meant that that CCC 308 includes a private library 318 that cannot be independently accessed by either merchants or end users. It should be understood that the present invention can be designed so that both sides are public or private, or any combination thereof. However, for security, it is desirable that the public 310 and private 312 sides are maintained as illustrated and described. It should be understood that described herein is a very specific, non-limiting example of communication pathways between the various components that are necessary to operate the present invention. In other words, although specific paths of communication have been described between the various components, the present invention is not intended to be limited thereto as other suitable communication paths exist by which the requisite information can be communicated between the components.

On the public side 310 of the CCC 308 is a merchant accessible application programming interface (API) 314 and a user accessible API 316. The merchant accessible API 314 is the API that communicates between the Merchant Web Server 304 and Private Library 318, while the user accessible API 316 is the API that communicates between the User's Mobile Device 328 and Private Library 318.

As noted above, the merchant web server 304 securely transmits 306 metadata to a content control center (CCC) 308 or, more specifically, to the merchant API 314 within the CCC 308, which thereafter transmits 320 the metadata to the private library 318. The metadata includes any applicable information pertaining to the locked content, user, merchant, etc., non-limiting examples of which include a description of the locked content, a price for unlocking the locked content, a merchant ID, a timestamp, and identifying information about the user's mobile device.

As noted above, on the private side 312 of the CCC 308 is a private library 318. The private library 318 receives the metadata and associates it with a unique alphanumeric value (unique ID). It should be understood that although the present invention describes the unique ID in terms of an alphanumeric value, the present invention is not intended to be limited thereto as any suitable unique identifier or value can be used to generate a unique ID. The unique ID is then transmitted 322 through the merchant API 314 and along 324 to the merchant web server 304.

After being received by the merchant web server 304, the unique ID is transmitted 326 to a web browser with instructions that the unique ID be displayed as a scannable code on a webpage as viewable on the user's computing device 300. The scannable code is any suitably scannable item, non-limiting examples of which include barcode, a QR code, images, etc.

In order to unlock the locked content, the user would then use an application on a mobile device (such as a smart phone) and the mobile device's sensor (e.g., camera) to scan 330 the scannable code as displayed on the user's computing device 300. The “scan” can be an actual visual or optical scan of the scannable code (using a camera or sensor) or an “intent action” where the user's mobile device selects the barcode.

The intent action is applicable when the user is attempting to access material on the user's mobile device itself. In this case, the user's mobile device 328 and computing device 300 would be a single machine as opposed to two separate devices (as illustrated in FIG. 3).

The application as stored on the mobile device 328 would then convert the scan of the scannable code into its corresponding constituent alphanumeric value and transmit 332 a user identification and the alphanumeric value to the user API 316. In another aspect, the mobile device 328 could skip the converting step and transmit an image of the scannable code to the CCC 308, which would then convert the scannable code into its corresponding constituent alphanumeric value.

It should be noted that each user is required to have a unique identifier (user identification), which can be associated with them through any suitable technique. For example, the user could create an account with a main system as integrated with the CCC 308. As another example, when downloading an application into their mobile device 328, the application either integrates with the user's mobile plan or asks the user for account information. Optionally, the system can require that the user be further verified by logging on to another account that the system is linked to such as Facebook, Twitter, gmail, etc.

The alphanumeric value is then transmitted 334 to the private library 318, which retrieves the metadata (e.g., content description and price) associated with the scannable code based on the alphanumeric value. In this example, the content description and price are then transmitted 336 through the user accessible API 316 and back 338 to the user's mobile device 328 for display to the user with an action item for user approval. It should be noted that the action item is associated with the unique ID

In the example of the metadata being content description and price, the action item is a command/request to unlock the described content for the displayed price. Thus, the content description and price are displayed as the action item related to the unique ID for user approval. In other words, the unique ID represents locked content on the webpage such that the action item is a content description of locked content and a price for unlocking the locked content for access by the user on the user's mobile device 328.

The user can provide approval by initiating a “yes” or “approve” command on their mobile device 328 using the application that is operably part of the present invention. Once the user approves the action item, their approval (via an approval command) is transmitted 340 through the user accessible API 316 to 342 to the private library 318, where it is recorded as a purchase transaction. A purchase confirmation is transmitted 344 back through the user accessible API 316 and to 346 the user's mobile device 328.

Additionally, once authorization is received from the user, an authorization command or message is transmitted 348 through the merchant accessible API 314 and to 350 the merchant web server 304.

It should be noted that in one non-limiting example, the web browser on the user's computing device 300 is continuously or periodically polling 352 the merchant web server 304 for access authorization. As can be appreciated by one skilled in the art, there may be other techniques for providing access authorization, such as the merchant web server 304 sending an authorization text (via mobile telephone systems) with an unique code to the computer device3 300. Thus, the polling 352 is but one non-limiting example by which the user's computing device 300 can obtain authorization. Upon receiving authorization, the merchant web server 304 unlocks the locked content to allow the user to access the content on the user's computing device 300. The content is unlocked using any suitable technique. As a non-limiting example, the merchant web server 304 simply opens the content for viewing/access.

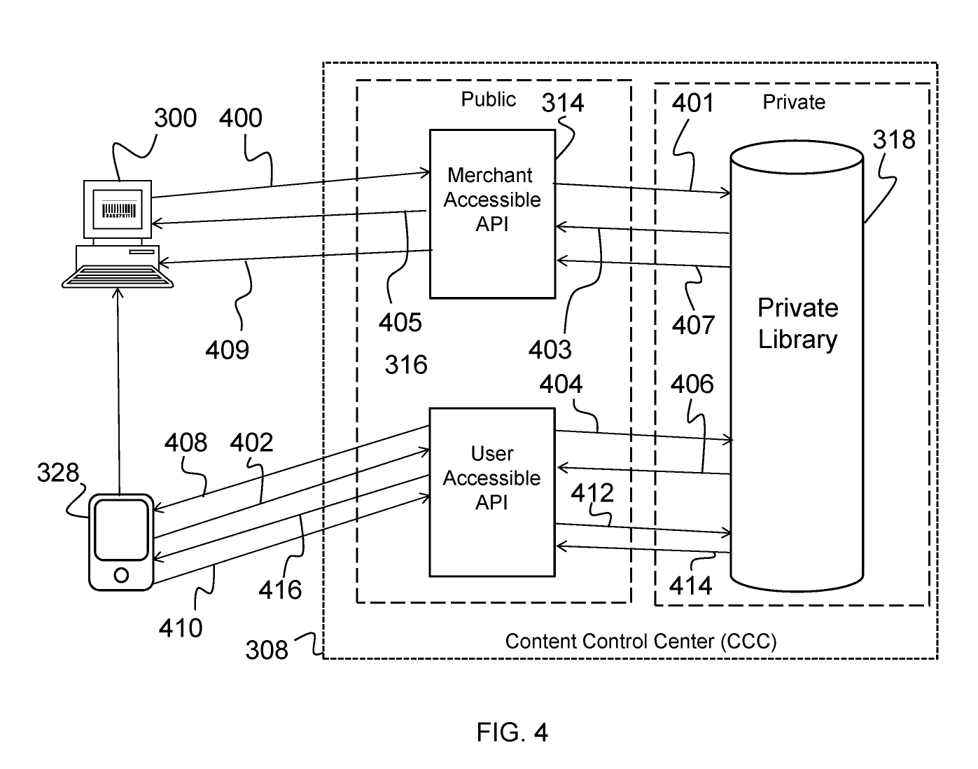

In another aspect and as depicted in FIG. 4, the present invention can be extended to allow for donation authorization. Thus, in this aspect, the unique ID represents an online donation such that the at least one action item is a description of the organization receiving the donation and an amount of the donation. Through receiving user approval and facilitating the at least one action item, a donation is provided to the organization receiving the donation.

Although a somewhat simplified version of that depicted in FIG. 3, as shown in FIG. 4, many of the features described above are also operable when adapted to facilitating donations or payments without the extra step of unlocking actual online content. For example, should a user decide to donate or provide payment to a particular cause, the user can use their computing device 300 to navigate the internet and access and load various web pages (e.g., such as a charity or political campaign). In loading the webpage (before, during, and/or after), a request is sent 400 through the merchant accessible API 314 and to 401 the private library 318 for a unique ID. Thereafter, the unique ID is transmitted 403 back through the merchant accessible API 314 and to 405 a web browser (on the user's computing device 300) with instructions that the unique ID be displayed as a scannable code (e.g., scannable barcode, QR code, etc.) on a webpage. It should be noted that the process described above for requesting and transmitting the unique ID can alternatively be mitigated to some extent in that the system can be formed such that it automatically generates a unique ID each time the webpage is loaded without the described request process.

After loading the webpage, a user can utilize their mobile device 328 and the mobile device's sensor (e.g., camera) to scan 330 the scannable code as displayed on the user's computing device 300. As was the case above, the “scan” can be an actual visual or optical scan of the scannable code (using a camera or sensor) or an “intent action” where the user's mobile device selects the barcode. Again, the intent action is applicable when the user is attempting to access material on the user's mobile device 328 itself, such that the user's mobile device 328 and computing device 300 would be a single device as opposed to two separate devices.

Upon receiving the scan of the scannable code on the user's mobile device 328, the mobile device 328 converts the scan of the scannable code into its corresponding constituent alphanumeric value. The user identification and the alphanumeric value are then transmitted 402 to the CCC 308 and its user accessible API 316. Within the CCC 308, the user accessible API 316 sends 404 and retrieves 406 (from the private library 318) metadata associated with the scannable code based on the alphanumeric value. In this example, the metadata can include a description of the organization receiving the donation and an amount of the donation. Thus, in this non-limiting example, the description of the organization receiving the donation and an amount of the donation are transmitted 408 for display on the user's mobile device 328. Again, in this non-limiting example, the organization receiving the donation and the amount of the donation are displayed as the action item related to the unique ID for user approval.

The user can provide approval through selecting, clicking, activating, actuating, etc., the applicable feature on their mobile device 328. As a non-limiting example, a “donate” icon can be provided. Thus, but clicking or selecting the “donate” icon, the user is providing explicit approval into the system.

Upon receiving user approval, the approval is transmitted 410 through the user accessible API 316 and to 412 the private library 318 to be recorded as an approved donation transaction. For confirmation, the system optionally transmits a donation confirmation 414 back through the user accessible API and to 416 the user's mobile device 328.

It should be noted that described above is but one aspect of a donation system implementing the present invention and that other aspects are to be within the scope of the present invention. For example, when the web page loads for a merchant who is soliciting a donation, the merchant has simply already placed a scannable code image on his website (or email or flier, or anywhere, really) that the merchant has already generated. The scannable code is a unique code that is associated with the donation cause, etc. It should be noted that there is nothing to stop a merchant who is soliciting donations to have the scannable code refreshed on each page load to imitate the unlocking process (as described above). However, since there is no unlocking of actual media content, it is not actually necessary to refresh the scannable code on each page load.

An example illustrating this concept is as follows. Assume “Church A” becomes an affiliated merchant that employs the present invention. For example, “Donation Company” is a company that could employ the present invention to allow merchants to solicit and accept donations via user's mobile phones. Church A may want to solicit small donations from their church members (who are, in turn, customers of Donation Company. The church would go to its own account on the Donation Company's website and generate a “campaign.” One example of a campaign they might create could be called “Help buy turkey dinners for the homeless,” and they set the price at $2. Donation Company will generate one unique barcode for this campaign. That barcode is now usable in any form, anywhere. The church will probably include the barcode in the church brochure on the Sunday prior to Thanksgiving. Any member of the church who has the Donation Company app or a Donation Company account can scan that barcode and thus make a $2 donation to the church's effort to buy Turkey dinners for homeless people.

Thus, using either of the aspects described above, through receiving user approval and facilitating the at least one action item, the system allows a user to scan a scannable code on the user's mobile device and, upon approval by the user, facilitate the at least one action item (i.e., provide a donation to the desired organization or campaign, etc.).

It should be noted that although the description above describes transmitting the metadata back to the user's mobile device 328 for confirmation, the present invention is not intended to be limited thereto as other communication pathways exist. For example, the metadata can instead be transmitted 407 through the merchant accessible API 314 and to 409 the computing device 300 for display and approval, with the approval transmitted back through merchant accessible API 314. As another example, if the computer device 300 and mobile device 328 are one and the same, then the communication pathways are largely reduced. Thus, as can be appreciated by one skilled in the art and as noted above, the specific communication pathways as described are provided as one non-limiting example as the invention is not intended to be limited thereto.

What is claimed is:

1. A system for controlling access to content, the system comprising:
one or more processors and a memory, the memory having instructions encoded thereon such that upon execution, the processor performs operations of:
transmitting a unique ID to a web browser with instructions that the unique ID be displayed as a scannable code on a webpage;
receiving scan information regarding a scan of the scannable code on a user's mobile device; and
causing to be displayed at least one action item related to the unique ID to a user on the user's mobile device for user approval; and
receiving user approval and facilitating the at least one action item, thereby allowing a user to scan a scannable code on the user's mobile device and, upon approval by the user, facilitate the at least one action item.

2. The system as set forth in claim 1, wherein the unique ID is associated with locked content on the webpage such that the at least one action item includes a content description of locked content and a price for unlocking the locked content for access by the user on the user's mobile device, wherein through receiving user approval and facilitating the at least one action item, the content is unlocked.

3. The system as set forth in claim 2, wherein before transmitting the unique ID, the system performs operations of:
causing a webpage to be loaded having locked content on a user's computing device and transmitting a request to a merchant web server for the scannable code;
sending metadata from the merchant web server to a content control center (CCC);
associating the metadata with a unique alphanumeric value, the unique alphanumeric value being the unique ID; and
transmitting the unique ID from the CCC to the merchant web server, such that the unique ID can thereafter be transmitted via the act of transmitting a unique ID to a web browser with instructions that the unique ID be rendered as a scannable code on a webpage.

4. The system as set forth in claim 3, wherein the system further performs operations of:
converting the scan of the scannable code into its corresponding constituent alphanumeric value;
transmitting at least one of a user identification and the alphanumeric value to the CCC;
retrieving, in the CCC, the metadata associated with the scannable code based on the alphanumeric value; and
transmitting the content description and price for display on the user's mobile device, with the content description and price being displayed as the action item related to the unique ID for user approval.

5. The system as set forth in claim 4, wherein receiving user approval and facilitating the at least one action item further comprises operations of:
transmitting user approval to the CCC;
recording the user approval as a purchase transaction;
transmitting a purchase confirmation from the CCC to the user's mobile device;
sending authorization from the CCC to the merchant web server;
polling the merchant web server for access authorization using the web browser on the user's computing device; and
upon authorization, unlocking the locked content for access by the user on the user's computing device.

6. The system as set forth in claim 5, wherein the metadata includes information selected from a group consisting of a description of the locked content, a price for unlocking the locked content, a merchant ID, a timestamp, and identifying information about the user's mobile device.

7. The system as set forth in claim 6, wherein in receiving a scan of the scannable code on a user's mobile device, the scan can be an actual visual or optical scan of the scannable code or an intent action where the user's mobile device selects the barcode.

8. The system as set forth in claim 1, wherein the unique ID represents an online donation such that the at least one action item is a description of the organization receiving the donation and an amount of the donation, wherein through receiving user approval and facilitating the at least one action item, a donation is provided to the organization receiving the donation.

9. The system as set forth in claim 8, further comprising operations of:
converting, on the user's mobile device, the scan of the scannable code into its corresponding constituent alphanumeric value;
transmitting a user identification and the alphanumeric value to a content control center (CCC);
retrieving, at the CCC, metadata associated with the scannable code based on the alphanumeric value;
transmitting the description of the organization receiving the donation and an amount of the donation for display on the user's mobile device, with the organization receiving the donation and the amount of the donation being displayed as the action item related to the unique ID for user approval.

10. The system as set forth in claim 9, wherein receiving user approval and facilitating the at least one action item further comprises operations of:
transmitting user approval to the CCC;
recording the user approval as a donation transaction; and
transmitting a donation confirmation from the CCC to the user's mobile device.

11. A computer implemented method for controlling access to content, comprising an act of:
causing one or more processors to execute instructions encoded upon a memory, such that upon execution, the one or more processors perform operations of:
transmitting a unique ID to a web browser with instructions that the unique ID be displayed as a scannable code on a webpage;
receiving scan information regarding a scan of the scannable code on a user's mobile device; and
causing to be displayed at least one action item related to the unique ID to a user on the user's mobile device for user approval; and
receiving user approval and facilitating the at least one action item, thereby allowing a user to scan a scannable code on the user's mobile device and, upon approval by the user, facilitate the at least one action item.

12. The computer implemented method as set forth in claim 11, wherein the unique ID is associated with locked content on the webpage such that the at least one action item includes a content description of locked content and a price for unlocking the locked content for access by the user on the user's mobile device, wherein through receiving user approval and facilitating the at least one action item, the content is unlocked.

13. The computer implemented method as set forth in claim 12, wherein before transmitting the unique ID, the method comprises acts of:
causing a webpage to be loaded having locked content on a user's computing device and transmitting a request to a merchant web server for the scannable code;
sending metadata from the merchant web server to a content control center (CCC);
associating the metadata with a unique alphanumeric value, the unique alphanumeric value being the unique ID; and
transmitting the unique ID from the CCC to the merchant web server, such that the unique ID can thereafter be transmitted via the act of transmitting a unique ID to a web browser with instructions that the unique ID be rendered as a scannable code on a webpage.

14. The computer implemented method as set forth in claim 13, further comprising acts of:
converting the scan of the scannable code into its corresponding constituent alphanumeric value;
transmitting at least one of a user identification and the alphanumeric value to the CCC;
retrieving, in the CCC, the metadata associated with the scannable code based on the alphanumeric value; and
transmitting the content description and price for display on the user's mobile device, with the content description and price being displayed as the action item related to the unique ID for user approval.

15. The computer implemented method as set forth in claim 14, wherein receiving user approval and facilitating the at least one action item further comprises acts of:
transmitting user approval to the CCC;
recording the user approval as a purchase transaction;
transmitting a purchase confirmation from the CCC to the user's mobile device;
sending authorization from the CCC to the merchant web server;
polling the merchant web server for access authorization using the web browser on the user's computing device; and
upon authorization, unlocking the locked content for access by the user on the user's computing device.

16. The computer implemented method as set forth in claim 15, wherein the metadata includes information selected from a group consisting of a description of the locked content, a price for unlocking the locked content, a merchant ID, a timestamp, and identifying information about the user's mobile device.

17. The computer implemented method as set forth in claim 16, wherein in receiving a scan of the scannable code on a user's mobile device, the scan can be an actual visual or optical scan of the scannable code or an intent action where the user's mobile device selects the barcode.

18. The computer implemented method as set forth in claim 11, wherein the unique ID represents an online donation such that the at least one action item is a description of the organization receiving the donation and an amount of the donation, wherein through receiving user approval and facilitating the at least one action item, a donation is provided to the organization receiving the donation.

19. The computer implemented method as set forth in claim 18, further comprising acts of:
converting, on the user's mobile device, the scan of the scannable code into its corresponding constituent alphanumeric value;
transmitting a user identification and the alphanumeric value to a content control center (CCC);
retrieving, at the CCC, metadata associated with the scannable code based on the alphanumeric value;
transmitting the description of the organization receiving the donation and an amount of the donation for display on the user's mobile device, with the organization receiving the donation and the amount of the donation being displayed as the action item related to the unique ID for user approval.

20. The computer implemented method as set forth in claim 19, wherein receiving user approval and facilitating the at least one action item further comprises acts of:
transmitting user approval to the CCC;
recording the user approval as a donation transaction; and
transmitting a donation confirmation from the CCC to the user's mobile device.

21. A computer program product for controlling access to content, the computer program product comprising computer-readable instructions stored on a non-transitory computer-readable medium that are executable by a computer for causing the computer to perform operations of:
transmitting a unique ID to a web browser with instructions that the unique ID be displayed as a scannable code on a webpage;
receiving scan information regarding a scan of the scannable code on a user's mobile device; and
causing to be displayed at least one action item related to the unique ID to a user on the user's mobile device for user approval; and
receiving user approval and facilitating the at least one action item, thereby allowing a user to scan a scannable code on the user's mobile device and, upon approval by the user, facilitate the at least one action item.

22. The computer program product as set forth in claim 21, wherein the unique ID is associated with locked content on the webpage such that the at least one action item includes a content description of locked content and a price for unlocking the locked content for access by the user on the user's mobile device, wherein through receiving user approval and facilitating the at least one action item, the content is unlocked.

23. The computer program product as set forth in claim 22, wherein before transmitting the unique ID, the computer performs operations of:
causing a webpage to be loaded having locked content on a user's computing device and transmitting a request to a merchant web server for the scannable code;
sending metadata from the merchant web server to a content control center (CCC);
associating the metadata with a unique alphanumeric value, the unique alphanumeric value being the unique ID; and
transmitting the unique ID from the CCC to the merchant web server, such that the unique ID can thereafter be transmitted via the act of transmitting a unique ID to a web browser with instructions that the unique ID be rendered as a scannable code on a webpage.

24. The computer program product as set forth in claim 23, further comprising instructions for causing the computer to perform operations of:
converting the scan of the scannable code into its corresponding constituent alphanumeric value;
transmitting at least one of a user identification and the alphanumeric value to the CCC;
retrieving, in the CCC, the metadata associated with the scannable code based on the alphanumeric value; and
transmitting the content description and price for display on the user's mobile device, with the content description and price being displayed as the action item related to the unique ID for user approval.

25. The computer program product as set forth in claim 24, wherein receiving user approval and facilitating the at least one action item further comprises operations of:
transmitting user approval to the CCC;
recording the user approval as a purchase transaction;
transmitting a purchase confirmation from the CCC to the user's mobile device;
sending authorization from the CCC to the merchant web server;
polling the merchant web server for access authorization using the web browser on the user's computing device; and
upon authorization, unlocking the locked content for access by the user on the user's computing device.

26. The computer program product as set forth in claim 25, wherein the metadata includes information selected from a group consisting of a description of the locked content, a price for unlocking the locked content, a merchant ID, a timestamp, and identifying information about the user's mobile device.

27. The computer program product as set forth in claim 26, wherein in receiving a scan of the scannable code on a user's mobile device, the scan can be an actual visual or optical scan of the scannable code or an intent action where the user's mobile device selects the barcode.

28. The computer program product as set forth in claim 21, wherein the unique ID represents an online donation such that the at least one action item is a description of the organization receiving the donation and an amount of the donation, wherein through receiving user approval and facilitating the at least one action item, a donation is provided to the organization receiving the donation.

29. The computer program product as set forth in claim 28, further comprising instructions for causing the computer to perform operations of:
converting, on the user's mobile device, the scan of the scannable code into its corresponding constituent alphanumeric value;
transmitting a user identification and the alphanumeric value to a content control center (CCC);
retrieving, at the CCC, metadata associated with the scannable code based on the alphanumeric value;
transmitting the description of the organization receiving the donation and an amount of the donation for display on the user's mobile device, with the organization receiving the donation and the amount of the donation being displayed as the action item related to the unique ID for user approval.

30. The computer program product as set forth in claim 29, wherein receiving user approval and facilitating the at least one action item further comprises operations of:
transmitting user approval to the CCC;
recording the user approval as a donation transaction; and
transmitting a donation confirmation from the CCC to the user's mobile device.
